(19) United States
(12) Patent Application Publication
(10) Pub. No.: US 2026/0359678 A1
(43) Pub. Date: Nov. 12, 2026

(54) SYSTEM AND METHOD FOR BAYESIAN PERFORMANCE ESTIMATION, BIAS CORRECTION, PREDICTIVE ANALYTICS, PROFILING, AND READINESS ASSESSMENT IN BOUNDED OUTCOME ENVIRONMENTS

(71) Applicant: KEVIN VENNARD, HOWELL, MI (US)

(72) Inventor: KEVIN VENNARD, HOWELL, MI (US)

(21) Appl. No.: 19/672,659

(22) Filed: May 10, 2026

Related U.S. Application Data
(60) Provisional application No. 63/804,301, filed on May 12, 2025.

(51) Int. Cl. G06N 5/04

(52) U.S. Cl. CPC G06N 5/04

(57) ABSTRACT

A computer-implemented performance analytics system receives bounded observations associated with entities, performance dimensions, evaluation contexts, and times. An evaluation-context bias correction engine generates bias-corrected observations from calibration residuals. The bias-corrected observations are transformed from a bounded score domain to an unbounded transformed domain using a monotonic differentiable link function. A recursive Bayesian state estimator operating in the transformed domain generates posterior latent performance estimates and posterior uncertainty estimates, which are converted back into the bounded domain. The system generates feature representations including features derived from posterior uncertainty trajectories and uses the feature representations to produce analytical outputs including normalized ratings, future performance predictions, multi-dimensional performance profiles, transition readiness assessments, similarity matches, and group-level analytics. The system is applicable to competitive gymnastics and other bounded outcome environments, including other sports, education, employment, healthcare, finance, insurance, manufacturing, supplier evaluation, and machine condition monitoring.

### CROSS REFERENCE TO RELATED APPLICATIONS

This application claims the benefit of U.S. Provisional Patent Application No. 63/804,301, filed May 12, 2025, the entire disclosure of which is incorporated herein by reference.

### FIELD OF THE INVENTION

The present invention relates generally to systems and methods for estimating latent performance ability from noisy, bounded observations in competitive scoring environments. More specifically, the invention relates to a multi-stage computational pipeline that applies mathematical domain transformation, Bayesian sequential estimation, multi-stage evaluator bias correction, multi-layer feature engineering, survivorship-bias-corrected predictive modeling, psychometric trait profiling derived from Bayesian posterior dynamics, targeted readiness assessment, historical similarity matching, team-level performance analytics, and recruiting benchmarking to produce performance ratings, predictions, athlete profiles, advancement assessments, team analytics, and recruiting guidance from bounded continuous performance scores.

While the preferred embodiment is described in the context of competitive gymnastics, the methods and systems described herein are applicable to any domain in which: (a) performance is measured on a bounded continuous scale; (b) evaluator or environmental bias contaminates observed measurements; (c) performers advance through discrete competitive levels or tiers; and (d) longitudinal performance tracking enables Bayesian estimation of latent ability. Such domains include, without limitation, competitive diving, figure skating, surfing, skateboarding, martial arts, equestrian dressage, and synchronized swimming, as well as non-athletic domains such as educational assessment, product quality scoring, and professional skill certification where bounded performance metrics are subject to evaluator variability.

### BACKGROUND OF THE INVENTION

This is usually separate from the Abstract section found later in the document. In competitive athletic environments where performance is evaluated by human judges or panels, observed scores reflect a mixture of the athlete's true ability, evaluator tendencies (leniency or strictness), day-to-day performance variation, environmental factors, and the nonlinear relationship between effort and score near the boundaries of the scoring scale. These confounding factors prevent raw observed scores from serving as reliable indicators of an athlete's latent ability.

Existing approaches to athletic performance rating fall into two categories, neither of which adequately addresses bounded continuous scoring environments:

Game-outcome rating systems (such as Elo, Glicko-2, and TrueSkill) process binary or ordinal outcomes (win, loss, draw) and are mathematically unsuitable for continuous performance scores. These systems cannot capture the magnitude of performance differences (a 9.8 that loses to a 9.9 is treated identically to a 7.0 that loses to a 9.9). Additionally, these systems were designed for head-to-head competition and do not model the judged-performance paradigm where athletes compete against an absolute standard rather than against each other.

Simple statistical aggregation (such as running averages, weighted averages, or z-score normalization) fails to account for the nonlinear difficulty gradient inherent to bounded scoring scales, where marginal improvement becomes exponentially harder near the scoring ceiling. A 0.1-point improvement at 9.5 on a 0-10 scale represents substantially more skill gain than a 0.1-point improvement at 8.0, but simple averages treat both equally.

Furthermore, no existing system addresses the combination of evaluator bias correction at the granular panel level, context-dependent state transitions (level changes, seasonal periodicity), survivorship bias in predictive modeling, and the derivation of multi-dimensional performance profiles from Bayesian posterior state dynamics.

There is therefore a need for a system and method that processes bounded continuous performance scores through a mathematically rigorous pipeline to produce bias-corrected performance estimates, uncertainty-aware ratings, multi-path predictions, psychometric profiles, and advancement readiness assessments.

### SUMMARY OF THE INVENTION

The present invention provides a system and method for estimating latent performance ability from noisy, bounded observations. In one embodiment, the system comprises a multi-stage computational pipeline including:
An evaluator bias estimation module that identifies calibration references among historical performers, computes residuals against rolling-window expected performance, applies asymmetric outlier removal, and processes raw bias estimates through a multi-stage statistical pipeline comprising empirical centering, evidence-based shrinkage, and bounded compression applied in a non-commutative sequence;
A Bayesian state estimation module that transforms bounded performance scores into an unbounded mathematical domain via a link function (such as, without limitation, a logit, probit, or complementary log-log transformation), applies sequential Bayesian filtering with a state-dependent derivative bridge for cross-domain noise conversion and a context-dependent multi-modal prediction step, and converts posterior estimates back to the bounded domain;
A national baseline computation module (106) that computes dual-domain percentile distributions for both raw observed scores and Bayesian-filtered estimates;
A feature engineering module that constructs multi-layer analytical features including national positioning, Bayesian derivative dynamics, time-normalized trajectories, environmental context, difficulty-adjusted transition estimates, age-relative development features, and cross-domain interaction terms;
An age-modulation subsystem that, when age or developmental-stage data is available, adjusts process-noise parameters, transition-difficulty estimates, peer comparisons, and downstream feature generation to account for age-relative development and age-dependent performance variability;
A predictive modeling module that trains separate model populations for same-level and level-transition scenarios, applies a delta-target architecture anchored to the performer's current true-skill estimate, corrects survivorship bias in level-transition predictions by decomposing forecasts into an unbiased empirical center and a model-calibrated spread, applies empirical improvement ceilings for same-level predictions, and generates multi-path forecasts with uncertainty intervals;
A rating module that computes national percentile ratings via cumulative distribution evaluation with convergence-aware routing that applies a targeted certainty penalty to unconverged estimates;
A profiling module that derives orthogonal performance traits from Bayesian posterior state dynamics and normalizes them via distributional transformation to a guaranteed uniform scale, and that additionally aggregates individual profiles to produce program-level performance identities;
A readiness assessment module that classifies performers into three tiers based on composite performance percentile, applies machine learning scoring only to the ambiguous middle population, computes per-performer feature attribution aggregated into domain-interpretable category groups with separation of environmental baseline factors from individual readiness drivers, and positions each performance dimension against historical advancement reference distributions;
A similarity matching module that identifies historically comparable performers using multi-dimensional similarity scoring with adaptive kernel calibration anchored to the candidate window width, with separate national and program-specific matching pools;
A team analytics module that aggregates individual performer estimates to produce team-level performance metrics, coaching attribution via counterfactual prediction comparison, and competitive depth analysis; and
A recruiting benchmarking module that matches current performer estimates against historical distributions of performers who were recruited to programs at the next competitive tier, producing school-level, conference-level, and division-level benchmarks with year-over-year trend analysis, and optionally characterizing each program's recruiting trait identity by aggregating the multi-dimensional profiles of historically recruited performers.

In one aspect, the invention provides a computer-implemented system for generating normalized, predictive, and comparable performance metrics from bounded observational data, the system including one or more processors configured to receive performance data, estimate and correct evaluator bias using statistically constrained estimators, transform the data into a non-linear domain, and generate latent performance values using a recursive Bayesian state-space model. The system further derives temporal and statistical features from the latent performance values, generates forward-looking predictions using one or more machine learning models, and produces normalized ratings and outputs based on population-level distributions.

In another aspect, the invention provides methods for correcting evaluator bias, estimating latent performance, and generating predictive outputs, including embodiments employing logit-space transformations, Kalman filtering, uncertainty-based convergence adjustments, and survivorship-bias-corrected prediction models. The invention further provides methods for generating multi-dimensional performance profiles by deriving trait-based or behavioral metrics from statistical properties of the latent performance model, as well as methods for assessing readiness for transition or progression by applying predictive models to selected subsets of entities. In certain embodiments, additional features include distribution-based normalization, comparison against peer groups or population benchmarks, and dynamic updating of ratings over time.

While described in the context of athletic performance evaluation, the disclosed systems and methods are not so limited and may be applied to any domain involving bounded or semi-bounded measurements, including but not limited to other sports, competitive ranking systems, academic evaluation, workforce performance analytics, financial or investment performance assessment, medical outcome benchmarking, and risk or trust scoring systems. The components and steps described herein may be implemented in various combinations, sub-combinations, or alternative arrangements, and may be performed using different statistical models, machine learning techniques, or computational architectures without departing from the scope of the invention.

### BRIEF DESCRIPTION OF THE DRAWINGS

The accompanying drawings, which are incorporated in and constitute a part of this specification, illustrate example embodiments of the disclosed subject matter and, together with the description, serve to explain principles of the invention. The drawings are not necessarily to scale. Like reference numerals may designate like or corresponding elements throughout the several views. The illustrated embodiments are provided for purposes of explanation and are not intended to limit the scope of the claims.

FIG. 1 is a block diagram illustrating the overall architecture of the performance analytics system, showing the data flow from observed performance scores through the processing stages to the analytical product outputs, and illustrating the chain of dependency between modules.

FIG. 2 is a process flow diagram illustrating the score transformation and Bayesian state estimation module, including the mathematical domain transformation, context-dependent prediction step, correction step with derivative bridge, and inverse transformation.

FIG. 3 is a process flow diagram illustrating the multi-stage evaluator bias estimation pipeline, including calibration reference identification, expected performance computation, asymmetric outlier removal, and the three-stage guardrail pipeline applied in non-commutative order.

FIG. 4 is a process flow diagram illustrating the bias-corrected multi-path prediction system, including the delta-target architecture, split-population routing, survivorship bias correction with interpolated empirical center estimates, same-level improvement ceilings, and ensemble prediction with uncertainty intervals.

FIG. 5 is a process flow diagram illustrating the convergence-aware national rating system, including the convergence decision routing, conservative versus standard estimation, and cumulative distribution evaluation against a national reference population.

FIG. 6 is a block diagram illustrating the multi-dimensional performer performance profiling system, showing trait derivation from Bayesian posterior outputs and temporal patterns, and distributional normalization to a uniform scale.

FIG. 7 is a process flow diagram illustrating the targeted advancement readiness assessment system, including the three-tier classification, machine learning scoring of the ambiguous middle population with per-performer feature attribution, and per-dimension readiness positioning.

FIG. 8 is a process flow diagram illustrating the historical performer similarity matching system, including candidate pool construction, multi-dimensional similarity scoring with adaptive kernel calibration, advancement-outcome weighting, and program-specific matching.

FIG. 9 is a detailed process flow diagram illustrating the survivorship bias correction mechanism, showing the decomposition of predictions into an unbiased interpolated empirical center estimate and a model-calibrated spread estimate.

FIG. 10 is a block diagram illustrating the multi-layer feature engineering architecture, showing six feature computation layers that transform Bayesian estimator outputs into a multi-dimensional feature store for downstream machine learning.

FIG. 11 is a process flow diagram illustrating the team and program performance analytics module, including weighted team scoring, coaching attribution via counterfactual prediction comparison, and competitive depth analysis.

FIG. 12 is a process flow diagram illustrating the recruiting benchmarking system, including performer-to-program matching, school-level percentile positioning, conference-level comparative analysis, and year-over-year trend computation.

FIG. 13 is a simplified interface diagram illustrating the system's output for an individual performer profile, showing the integrated display of true-skill estimates, national ratings, performance profiles, predictions, readiness assessments, and comparable historical performers.

FIG. 14 is a simplified interface diagram illustrating the system's output for a team or program profile, showing team rankings, roster performance overview, coaching attribution metrics, and competitive depth visualization.

FIG. 15 is a simplified interface diagram illustrating the system's output for a national ranking view, showing ranked performers with percentile ratings, convergence indicators, and hierarchical geographic sub-rankings.

FIG. 16 is a simplified interface diagram illustrating the system's output for a comparative analysis view, showing side-by-side performer comparison across performance dimensions with overlaid profiles and similarity scoring.

### DETAILED DESCRIPTION

The following detailed description describes certain embodiments of the invention with reference to the accompanying drawings. The described embodiments are provided by way of example and not limitation. Various modifications, substitutions, combinations, sub-combinations, and equivalents may be made without departing from the scope of the invention as defined by the claims. Unless expressly stated otherwise, features described with respect to one embodiment may be used with, combined with, or substituted for features of another embodiment.

While the preferred embodiment is described in the context of competitive gymnastics, the system and methods are applicable to any bounded continuous scoring environment with evaluator variability and discrete competitive levels, as described in the Field of the Invention.

### Definitions and Non-Limiting Terminology

Bounded observation: means an observation, score, rating, measurement, rubric result, risk value, quality value, or other data value that is naturally bounded or normalized to a bounded interval, including without limitation a 0-to-10 score, 0-to-100 score, percentile, percentage, credit score, quality score, rating, or other bounded or semi-bounded metric.
Entity: means an individual performer, athlete, student, employee, patient, provider, machine, product, supplier, facility, organization, account, borrower, insured, portfolio, team, program, or other subject for which bounded observations are collected over time.
Performance dimension: means an event, skill, category, apparatus, subject area, job function, medical outcome category, operational metric, risk dimension, quality dimension, or other subdivision of an entity's observed performance.
Evaluation context: means an evaluator, judge, panel, venue, meet, facility, manager, teacher, institution, data source, market condition, environmental condition, inspection context, or other circumstance that may introduce systematic bias into bounded observations.
Tier transition: means a transition by an entity from one level, grade, rank, course, league, division, risk band, treatment stage, machine state, supplier class, or other discrete classification to another.
Posterior uncertainty trajectory: means a sequence of uncertainty values generated by a recursive Bayesian estimator across successive observations, including a rate of change of uncertainty, convergence pattern, stability measure, or other derivative feature derived from the estimator state.
Readiness output: means a score, label, recommendation, risk flag, transition probability, explanatory attribution, or other data output indicating whether an entity is ready for advancement, promotion, transition, intervention, maintenance, certification, recruitment, underwriting, or other future action.
Link function: means a mathematical transformation that maps a bounded or semi-bounded observation domain to an unbounded or differently scaled computational domain, and that is monotonic and at least piecewise differentiable over the domain of interest. A link function may include, without limitation, a logit transformation, probit transformation, complementary log-log transformation, arcsine square-root transformation, Box-Cox transformation, or a learned monotonic transformation. The link function may further include an associated inverse transformation for mapping values from the transformed domain back to the original bounded domain. The link function may also be associated with a derivative or Jacobian that is used to convert noise, variance, or other parameters between domains.
Calibration residual: means a difference, deviation, or error value computed between an observed bounded performance observation and a corresponding expected or reference performance value for a calibration entity. The expected or reference performance value may be derived from a rolling-window average, a weighted historical estimate, a Bayesian posterior estimate, or another statistical estimate of expected performance. Calibration residuals may be aggregated across multiple observations, entities, or evaluation contexts and may be filtered, weighted, or censored prior to use in bias estimation.
Evaluation-context bias: means a systematic deviation in observed bounded performance observations attributable to an evaluation context rather than to the underlying latent performance of the entity being evaluated. An evaluation context may include, without limitation, an individual evaluator, judging panel, grader, instructor, facility, venue, data source, environmental condition, or other contextual factor associated with the generation of the observation. Evaluation-context bias may be estimated from calibration residuals and may be expressed as an additive, multiplicative, or otherwise parameterized adjustment applied to observed bounded performance observations to produce bias-corrected observations.
Recursive Bayesian state estimator: means a computational process that updates an estimate of a latent state and an associated uncertainty over time as new observations are received, wherein the estimator maintains a posterior distribution or parameterization thereof and performs sequential predict and update operations. The recursive Bayesian state estimator may include, without limitation, a Kalman filter, extended Kalman filter, unscented Kalman filter, particle filter, variational Bayesian estimator, Gaussian process model, or other sequential Bayesian estimation technique. The estimator may operate in a transformed domain and may incorporate context-dependent prediction steps, dynamically adjusted noise parameters, and conversion of parameters between domains using derivatives of a transformation function.
Posterior uncertainty estimate: means a value, parameter, or set of parameters representing the uncertainty associated with a posterior estimate of a latent state produced by a recursive Bayesian state estimator after incorporation of one or more observations. The posterior uncertainty estimate may be expressed as a variance, standard deviation, covariance, confidence interval, credible interval, or other quantitative measure of dispersion or confidence. The posterior uncertainty estimate may vary over time as additional observations are incorporated and may be used to generate derived features, convergence indicators, confidence adjustments, predictive intervals, or decision-support outputs.

The term uncertainty estimate as used in figures refers to a posterior uncertainty estimate unless otherwise specified.

Unless expressly required by a claim, examples described in connection with competitive gymnastics are non-limiting preferred embodiments. The same computational architecture may be applied to other bounded outcome environments using domain-specific bounded observations, evaluation contexts, peer groups, and tier transitions.

Unlike a generic ranking or averaging system, the disclosed system changes how the computer represents, updates, stores, and transmits bounded observations by generating transformed-domain posterior state variables and uncertainty trajectories that are not present in the original data.

### I. System Overview

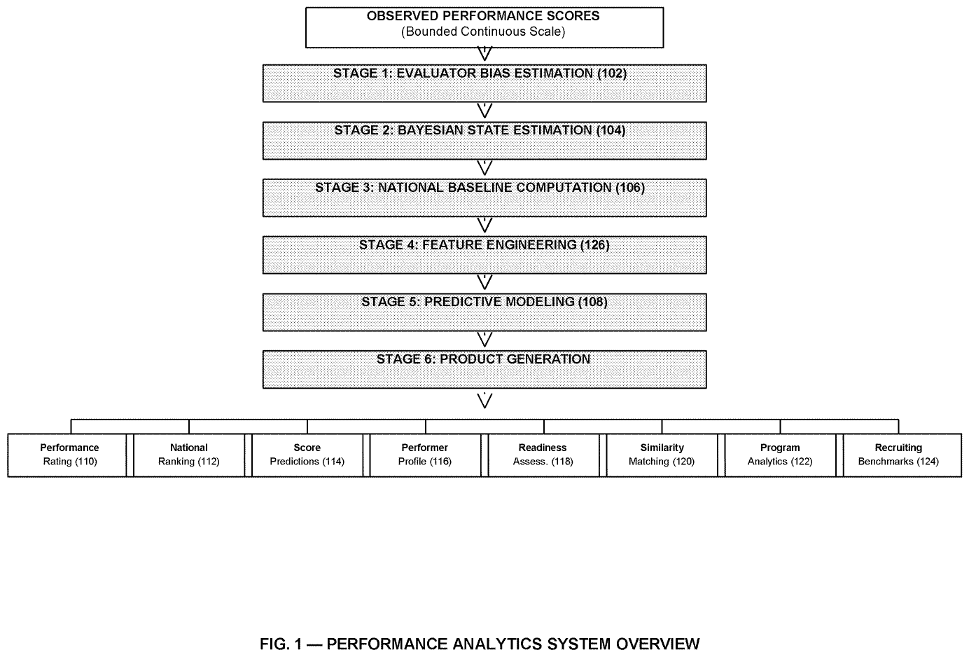

Referring to FIG. 1, the performance analytics system receives observed performance scores measured on a bounded continuous scale (in the preferred embodiment, a 0 to 10 scale, though the system is equally applicable to any bounded continuous scale such as 0 to 100, 0 to 6, or any arbitrary bounded range). The scores are processed through a series of interconnected modules to produce multiple categories of analytical products.

The bounded performance scale may represent, without limitation, scores awarded by human judges, automated scoring systems, peer evaluators, or any combination thereof. The scoring environment may include competitive athletics, academic assessment, professional skill evaluation, product quality inspection, or any domain where performance is measured on a bounded continuous scale subject to evaluator variability.

Chain of Dependency. A critical architectural feature of the system is the chain of dependency between modules. The evaluator bias estimation module (102) must execute before the Bayesian state estimation module (104), because the state estimator requires bias-corrected scores as input. The state estimator must execute before the feature engineering module (126), because features are derived from the estimator's posterior outputs. The feature engineering module must execute before the predictive modeling module (108), profiling module (116), readiness assessment module (118), and similarity matching module (120), because each consumes features produced by the upstream modules. This chain means the system is a unified invention: a competitor cannot replicate any downstream module without first building the complete upstream infrastructure. The survivorship-corrected predictions, for example, are impossible without the Bayesian estimator, which is impossible without the bias correction. Observed performance scores shown in FIG. 1 are examples of bounded performance observations. Group-level analytics outputs include, without limitation, team analytics, program analytics, recruiting benchmarks, and aggregated entity-level insights.

### II. Score Transformation and Bayesian State Estimation

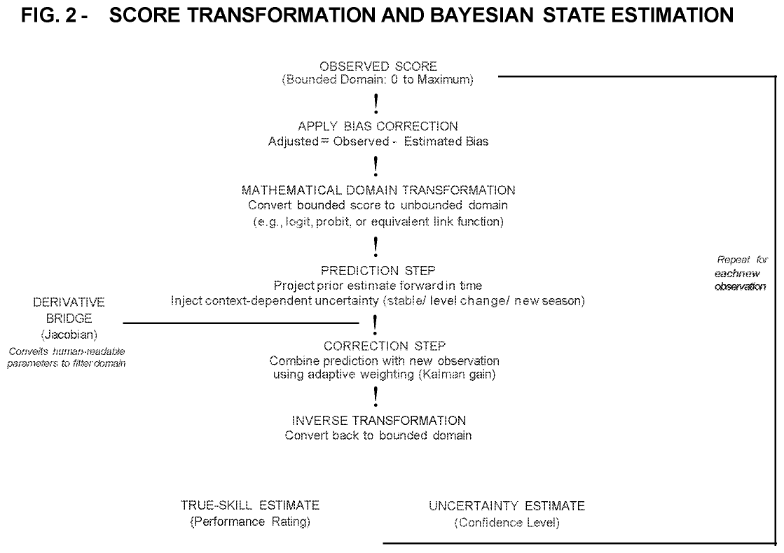

Referring to FIG. 2, the Bayesian state estimation module (104) processes each observed score through a predict-correct cycle operating in a mathematically transformed domain.

### A. Mathematical Domain Transformation

The system applies a mathematical link function that converts bounded performance scores into an unbounded domain suitable for recursive Bayesian estimation. In the preferred embodiment, the logit (log-odds) transformation is used: logit(s/M)=ln((s/M)/(1−s/M)), where s is the observed score and M is the maximum possible score. However, the invention is not limited to the logit transformation. Alternative embodiments may employ, without limitation, the probit transformation (inverse normal CDF), the complementary log-log transformation, the arcsine square-root transformation, or any monotonic, differentiable link function that maps a bounded interval to an unbounded domain while encoding the heteroscedastic difficulty gradient inherent to bounded scoring scales.

The essential function of the transformation is to convert the nonlinear relationship between effort and score (where marginal improvement becomes exponentially harder near the scoring ceiling) into an approximately linear relationship in the transformed domain. This linearization enables the application of standard linear Bayesian filtering techniques without requiring higher-order nonlinear filtering methods.

### B. Derivative Bridge (Jacobian)

The system maintains all tunable parameters in the original bounded domain (interpretable to domain experts such as coaches or evaluators) and dynamically converts them to the transformed domain at each filter iteration using the local Jacobian of the transformation. For the logit transformation, this derivative is d(score)/d(logit)=p×(1−p)×M, where p=score/M. This state-dependent conversion creates an adaptive filter that is automatically more responsive to changes at extreme scores (near the boundaries) and more conservative at moderate scores, without requiring explicit adaptive filtering machinery.

In alternative embodiments, the derivative bridge may employ numerical differentiation, automatic differentiation, or pre-computed lookup tables rather than closed-form Jacobian expressions.

### C. Context-Dependent Prediction Step

The prediction step adapts its behavior based on the performer's competitive context. In the preferred embodiment, three context modes are recognized:
Stable context: The performer is competing at the same competitive level within the same competitive season. Process noise (representing expected ability change between observations) is applied according to level-specific and event-specific calibration values.
Level-change context: The performer has advanced to a new competitive level. The system applies an empirically derived transition adjustment (representing the expected score change due to increased difficulty) and injects additional uncertainty into the posterior.
Season-boundary context: The performer's first observation in a new competitive season is detected. The system applies a seasonal adjustment (representing offseason variation) and injects additional uncertainty.

In alternative embodiments, additional context modes may include, without limitation, injury return, coaching change, facility change, equipment change, or rule/standard changes. The context detection mechanism may employ rule-based logic, machine learning classifiers, or a combination thereof.

### D. Correction Step and Posterior Output

The correction step applies standard Bayesian sequential updating: the system computes an adaptive weighting factor (analogous to the Kalman gain) that determines the relative trust placed on the new observation versus the prior estimate, updates the posterior mean (the true-skill estimate), and updates the posterior variance (the uncertainty estimate). The weighting factor is computed from the ratio of prior uncertainty to total uncertainty (prior plus measurement noise), where measurement noise is converted to the transformed domain via the derivative bridge. The posterior mean and variance are then converted back to the bounded domain via the inverse transformation.

Sufficient Statistic Property. An important architectural property of the Bayesian sequential estimator is that its posterior state (the mean and variance pair) constitutes a sufficient statistic: the entire history of prior observations is fully captured by the current posterior. This property enables warm-start processing, where the system can resume estimation from a stored checkpoint without re-processing historical observations, and enables parallel or incremental processing architectures.

In alternative embodiments, the Bayesian estimation may employ Extended Kalman Filtering, Unscented Kalman Filtering, particle filtering, variational inference, or Gaussian process regression. The essential requirement is that the estimator produces both a point estimate of latent ability and an uncertainty measure associated with that estimate.

### III. Multi-Stage Evaluator Bias Estimation

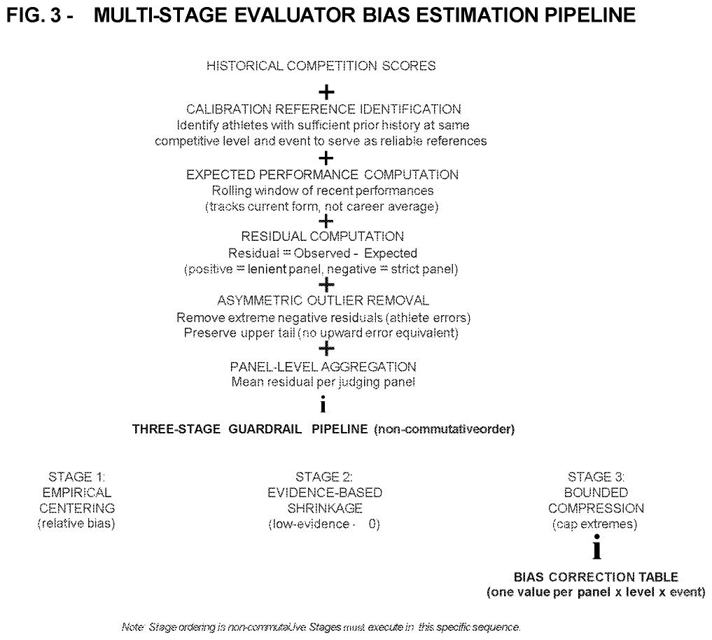

Referring to FIG. 3, the evaluator bias estimation module (102) estimates the systematic scoring tendency of each evaluator panel, judge, or evaluation environment using a multi-stage statistical pipeline.

### A. Calibration Reference Identification

The system identifies performers with sufficient prior competitive history at the same level and performance dimension to serve as reliable calibration references. In the preferred embodiment, a performer qualifies as a calibration reference if she has completed at least a minimum number (e.g., three) prior competitions at the same level and dimension, and if a rolling-window average of her recent performance is available. Performers who do not meet these criteria are excluded from bias estimation because their scores may reflect the difficulty transition to a new level or insufficient baseline history rather than evaluator tendencies.

In alternative embodiments, the calibration reference criteria may employ different minimum observation thresholds, different window sizes, weighted windows, exponential decay windows, or machine-learning-based eligibility classifiers.

### B. Asymmetric Outlier Removal

The system applies an asymmetric residual filter that censors the lower tail of the residual distribution while leaving the upper tail uncensored. This exploits a domain-specific asymmetry present in many bounded scoring environments: performers can experience catastrophic performance failures (falls, errors, equipment malfunctions) that produce large negative residuals, but there is no equivalent upward catastrophic event. Including catastrophic-failure residuals in bias estimation would falsely attribute the performer's error to evaluator strictness.

In alternative embodiments, the asymmetry may be reversed (censoring the upper tail) for domains where positive outliers are more likely to represent evaluator error than genuine performance, or the censoring threshold may be set adaptively based on the residual distribution's properties.

### C. Three-Stage Guardrail Pipeline

The aggregated panel bias estimate is processed through a three-stage pipeline, applied in the following non-commutative order:

Stage 1—Empirical centering: The population mean of all eligible panel bias estimates is subtracted from each panel's estimate, converting from absolute bias (deviation from a theoretical neutral evaluator) to relative bias (deviation from the average evaluator in the population). This prevents asymmetric penalty when the entire evaluator population trends in one direction.

Stage 2—Evidence-based shrinkage: Each panel's bias estimate is attenuated toward zero (the default assumption of no bias) in proportion to the strength of evidence. Panels with many calibration references retain most of their signal; panels with few references are aggressively shrunk toward zero. In the preferred embodiment, this is implemented as James-Stein shrinkage with a fixed skepticism constant, though Bayesian empirical shrinkage, ridge regression, or hierarchical Bayesian estimation may be used in alternative embodiments.

Stage 3—Bounded compression: Extreme bias values are compressed using a smooth bounding function that preserves full resolution within a normal operating range and asymptotically limits values to a maximum magnitude. In the preferred embodiment, a piecewise hyperbolic-tangent function is used with C1 continuity at the passthrough boundary, though sigmoid functions, Winsorized means, or other smooth bounding functions may be used in alternative embodiments.

The order of these stages is non-commutative: applying shrinkage before centering would shrink estimates toward a non-zero target (the population leniency), and applying bounded compression before shrinkage would compress values before their evidence strength has been assessed. The specific ordering addresses three distinct failure modes (population-level systematic bias, noise amplification from low evidence, and pathological outliers) in a sequence where each stage operates on the corrected output of the previous stage.

### IV. Bias-Corrected Multi-Path Prediction System

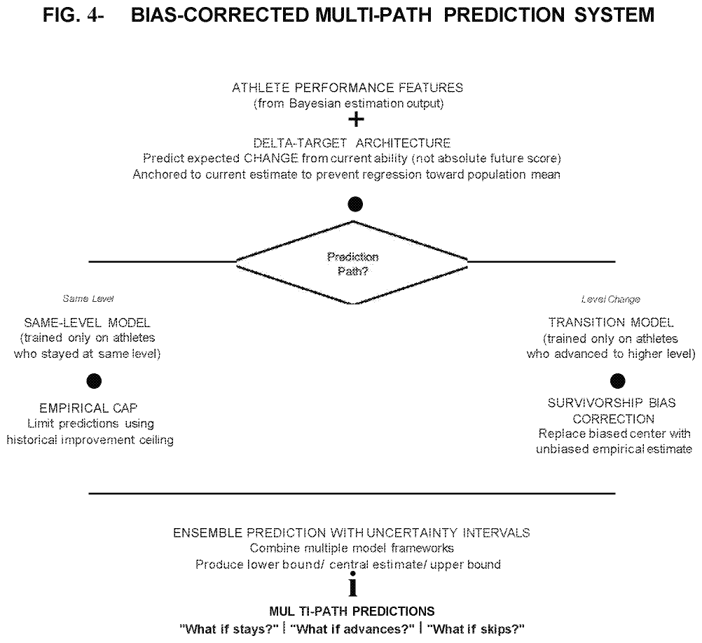

Referring to FIG. 4, the predictive modeling module (108) generates score predictions (114) and multi-path performance forecasts using a delta-target architecture with split-population training, survivorship bias correction, and empirical improvement ceilings.

### A. Delta-Target Architecture

The system predicts the expected change in performance (Δ=future performance−current estimate) rather than the absolute future performance level. The final prediction is reconstructed as: prediction=current_estimate+predicted_Δ. This architecture prevents the well-known regression-to-mean artifact that occurs when predicting absolute values, where predictions for high-performing performers systematically collapse toward the population mean. By predicting only the expected change, the model's output is anchored to the performer's current demonstrated ability.

In alternative embodiments, the anchor may be a raw observed average, a weighted average, or any point estimate of current ability. The delta target may be computed in the original domain, the transformed (e.g., logit) domain, or a percentile domain.

B. Split-Population Training with Counterfactual Routing

The system trains completely separate model ensembles for two populations: performers who remained at the same competitive level and performers who advanced to a higher level. At prediction time, each performer's features are routed to the appropriate population model based on the hypothetical path being predicted (e.g., “what if this performer stays?” uses the same-level model; “what if this performer advances?” uses the transition model). This asymmetry—training on historical outcomes but predicting on hypothetical paths—enables counterfactual analysis without cross-population contamination.

In the preferred embodiment, transition predictions are restricted to within-program pathways (e.g., a performer in a developmental track receives predictions only for the next level within that track, not for an alternative parallel track such as an exhibition program). This prevents cross-program contamination where scores from an easier parallel pathway inflate predictions through aggregation.

### C. Survivorship Bias Correction

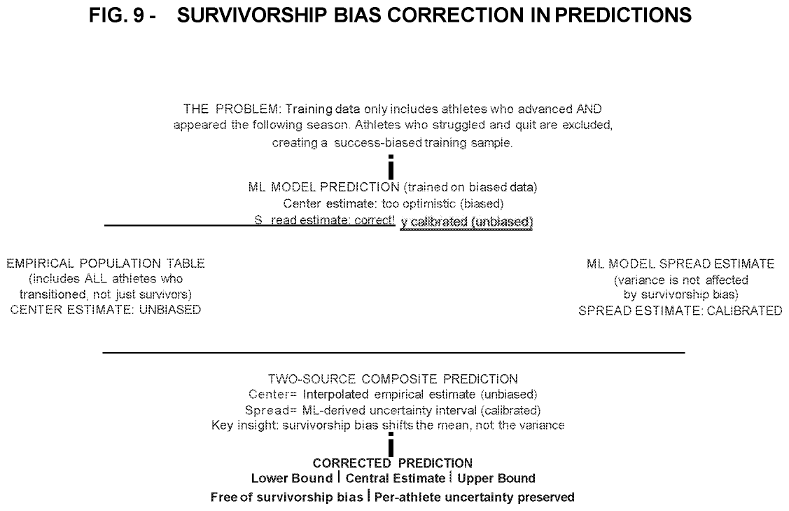

Referring to FIG. 9, the transition predictions are corrected for survivorship bias using a two-source composite. The training data for level-transition predictions contains only performers who advanced AND appeared in subsequent competition—a sample filtered by survival that systematically excludes negative outcomes (performers who advanced, struggled, and did not return). The system decomposes the prediction into two independently sourced components:
(1) The center estimate (expected value) is replaced by an interpolated empirical estimate derived from a population table that includes all performers who transitioned, regardless of subsequent appearance. In the preferred embodiment, the interpolation uses piecewise linear interpolation between quartile midpoints of the empirical distribution, indexed by the performer's current ability relative to peers at the same competitive level. This interpolation eliminates cliff effects that would occur with hard quartile binning (e.g., a performer at the 24th percentile receiving a substantially different prediction than one at the 26th percentile despite negligible real ability difference).
(2) The spread estimate (uncertainty interval) is preserved from the machine learning model, based on the statistical insight that survivorship bias shifts the conditional mean of the training data but does not substantially affect the conditional variance. The per-performer uncertainty is therefore correctly calibrated even though the center is biased.

This two-source composite corrects the systematic center bias while preserving per-performer uncertainty estimation. The approach is applicable to any predictive system where training data is filtered by a survival or selection process.

### D. Same-Level Empirical Improvement Ceiling

For same-level predictions (performers who remain at the same competitive level), the system applies an empirical improvement ceiling that caps the maximum predicted improvement based on historical data. In the preferred embodiment, the ceiling is derived from the empirical distribution of year-over-year score changes for performers at the same competitive level and performance dimension, set at a multiplier of the best-case historical growth for bottom-quartile performers. This prevents the machine learning model from extrapolating unrealistically large improvements for performers in the extreme lower tail of the ability distribution, where training data is sparse and dominated by atypical trajectories.

The ceiling is applied uniformly across quantile predictions (lower bound, central estimate, upper bound), preserving the model's calibrated spread while constraining only the center.

### V. Convergence-Aware National Rating System

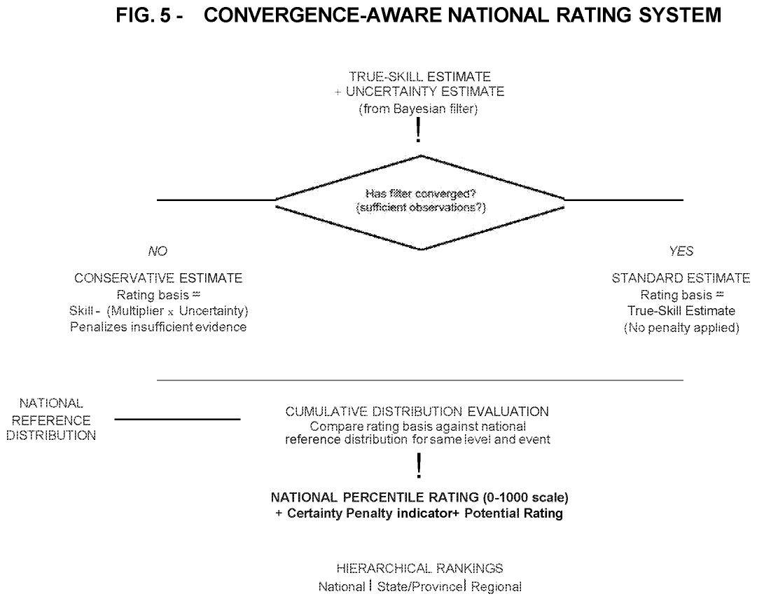

Referring to FIG. 5, the rating module (110) computes a national percentile rating by evaluating the cumulative distribution function (CDF) of the performer's performance estimate against the national reference distribution generated by the national baseline computation module (106) for the same competitive level and performance dimension.

The system routes performers to different rating bases depending on the convergence status of the Bayesian estimator. Performers with sufficient observations for the estimator to converge (in the preferred embodiment, two or more observations in the current competitive season) are rated on their raw true-skill estimate. Performers with insufficient observations (one observation) are rated on a conservative estimate: the true-skill estimate minus a multiplier times the posterior uncertainty. This routing reflects the statistical reality that the Bayesian estimator has not converged after a single observation, and rating an unconverged estimate at face value would produce unreliable rankings.

In the preferred embodiment, the convergence threshold (two observations) was determined by statistical analysis showing that posterior uncertainty decreases by approximately 35% from the first to the second observation but is statistically stable thereafter. Any penalty applied to performers with two or more observations would penalize performers who are more consistent than average—a counter-intuitive finding that demonstrates the non-obvious nature of the threshold selection.

The system additionally outputs a potential rating representing the unsuppressed estimate (what the rating would be without the certainty penalty), enabling users to assess the gap between the conservative and optimistic rating.

In alternative embodiments, the convergence threshold may be set at different observation counts, may vary by competitive level or dimension, or may be determined by a formal convergence test (such as a variance ratio test or a Gelman-Rubin diagnostic). The CDF evaluation may use, without limitation, a normal (Gaussian) CDF, an empirical CDF, a kernel density estimate, or any probability distribution fitted to the reference population.

### VI. Multi-Dimensional Performer Performance Profiling

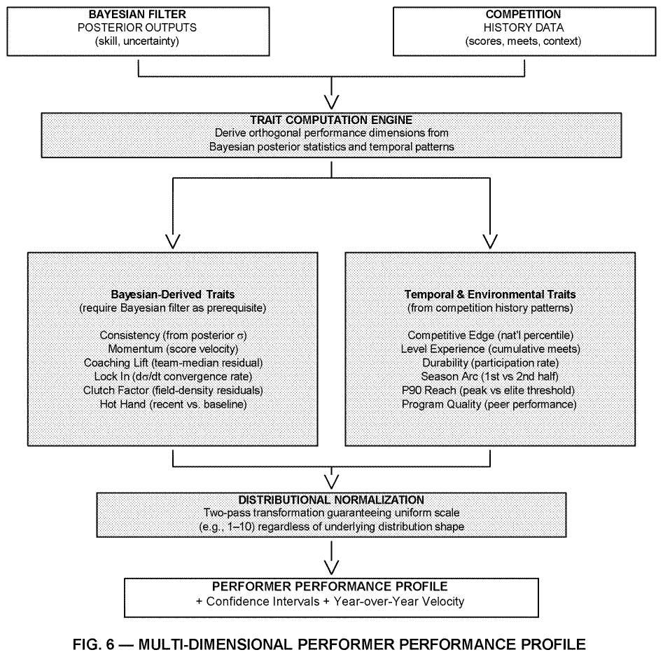

Referring to FIG. 6, the profiling module (116) derives a multi-dimensional performance profile for each performer by computing orthogonal traits from two categories of source data: (a) the internal state dynamics of the Bayesian estimator (posterior mean, posterior uncertainty, rate of change of uncertainty, cumulative bias exposure), and (b) temporal patterns in the competition history (velocity, acceleration, seasonal progression, competitive field context, environmental quality).

In the preferred embodiment, twelve traits are computed. A key innovation is that a substantial fraction of these traits (in the preferred embodiment, six of twelve) require a Bayesian state-space model as a prerequisite and cannot be computed from raw observed scores alone. For example, a “consistency” trait derived from the Bayesian posterior uncertainty (sigma) measures how confident the estimator is in its assessment of the performer, which is fundamentally different from the standard deviation of observed scores (which measures score variability without accounting for evaluator bias or the nonlinear scoring scale). Similarly, a “convergence rate” trait derived from the rate of change of posterior uncertainty (dsigma/dt) measures how quickly the estimator's confidence stabilizes—a measure of how predictable and consistent a performer is across competitions.

Each trait undergoes a distributional normalization that maps the raw trait value to a guaranteed uniform distribution on a bounded scale (e.g., 1 to 10) within each peer group (same competitive level, dimension, and season). In the preferred embodiment, a two-pass Blom normalization is used (within-group percentile ranking followed by inverse-normal-CDF transformation), though alternative embodiments may employ percentile ranking alone, quantile normalization, or any rank-preserving transformation that produces a comparable scale across traits with different natural distributions.

The profile includes confidence intervals for each trait (derived from propagating the Bayesian estimator's posterior uncertainty through the trait computation) and year-over-year velocity measures showing how each trait has changed relative to the prior season.

In alternative embodiments, the trait set may include additional dimensions such as recovery speed (post-failure score rebound), injury resilience, geographic competition adjustment, or age-relative development rate. The number of traits may range from as few as 4 to as many as 30 or more, depending on the domain and available data.

### VII. Targeted Advancement Readiness Assessment

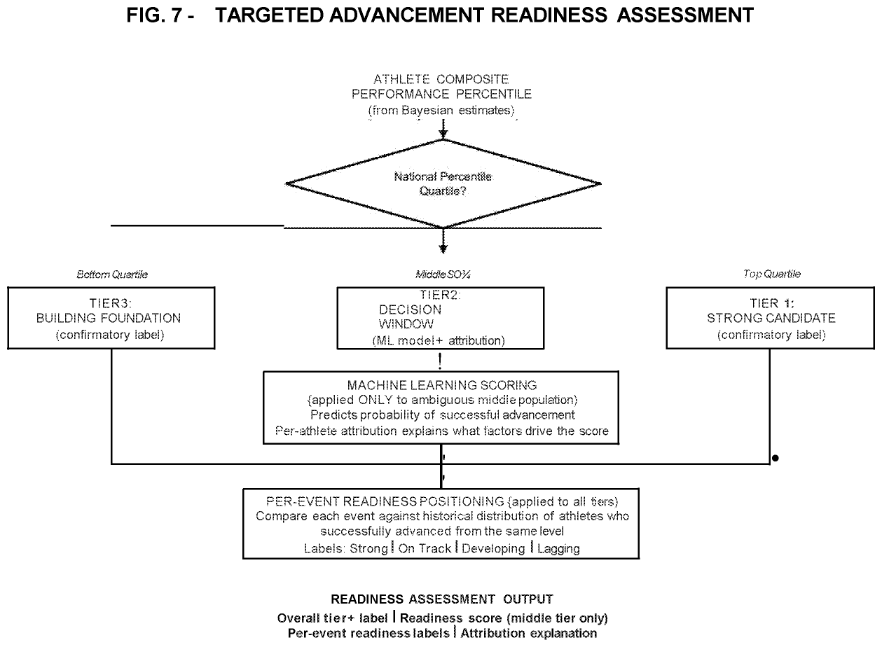

Referring to FIG. 7, the readiness assessment module (118) addresses the question: “Is this performer ready to advance to the next competitive level?” The system employs a three-tier architecture:
Top tier (e.g., top quartile of national composite performance percentile): Performers receive a confirmatory readiness label (e.g., “Strong Candidate”) without machine learning scoring, because their advancement readiness is not ambiguous.
Bottom tier (e.g., bottom quartile): Performers receive a confirmatory developmental label (e.g., “Building Foundation”) without machine learning scoring, because their need for continued development is not ambiguous.
Middle tier (e.g., interquartile range): Performers receive machine learning scoring with per-performer feature attribution, because these are the cases where the advancement decision is genuinely ambiguous and data-driven insight provides the most value.

For the middle tier, the system applies a pre-trained gradient-boosted decision tree model that predicts the probability of successful advancement (advancing to the next level AND achieving a specified performance threshold at that level). Per-performer feature attribution (in the preferred embodiment, using SHAP values) explains what specific factors drive each performer's readiness score.

In the preferred embodiment, the individual feature-level SHAP attribution values are aggregated into a plurality of domain-interpretable category groups (e.g., Event Performance, Balance, Program Context, Momentum, Experience), each representing a coherent dimension of advancement readiness. This aggregation transforms a high-dimensional vector of individual feature contributions into a small number of actionable insights that domain experts (coaches, parents, program administrators) can understand and act upon. The category definitions require domain expertise to design and are not derivable from the machine learning model alone.

Additionally, the feature attribution is separated into at least two layers: (i) a baseline layer representing environmental and contextual factors common to all performers at the same competitive level (e.g., level difficulty, historical advancement base rate), and (ii) an individual layer representing factors specific to the performer being assessed (e.g., momentum, event balance, consistency). This separation prevents environmental features from dominating the attribution for every performer at a given level, which would render the individual explanation useless for decision-making. The end user sees both layers but can distinguish between factors the performer can influence and factors that are properties of the competitive level itself.

Additionally, for all tiers, each individual performance dimension is positioned against a reference distribution of performers who historically advanced successfully from the same competitive level and dimension, producing per-dimension readiness labels (e.g., Strong, On Track, Developing, Lagging). This descriptive positioning is independent of the machine learning model and provides actionable guidance on which specific dimensions need development.

In alternative embodiments, the tier boundaries may use percentile thresholds other than quartiles, the machine learning model may employ neural networks, logistic regression, random forests, or any classification or regression framework, and the feature attribution may use LIME, integrated gradients, or any other interpretability method.

### VIII. Historical Performer Similarity Matching

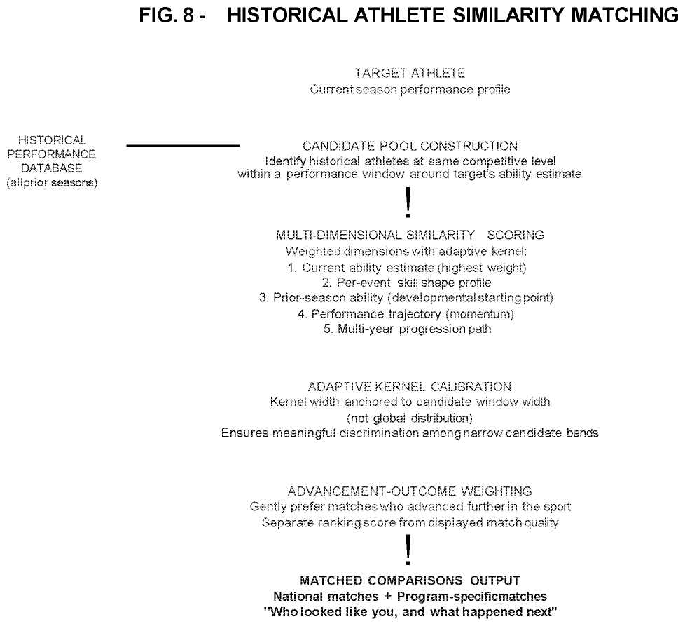

Referring to FIG. 8, the similarity matching module (120) identifies historically comparable performers by computing multi-dimensional similarity scores in a feature space anchored to the Bayesian-filtered true-skill estimate.

A. Candidate Pool Construction. The system first constructs a candidate pool of historical reference entities. In the preferred embodiment, the candidate pool includes historical performers at the same competitive tier as a target performer and within a candidate window of posterior latent performance estimates surrounding the target performer's posterior latent performance estimate. The candidate window limits the matching problem to historically plausible comparators and prevents distant population members from dominating computational resources.

Because the Bayesian filter strips evaluator-specific bias from the true-skill estimate, a score of X in one competitive season has the same ability-level meaning as a score of X in a different competitive season. This cross-season comparability is a direct consequence of the bias correction and Bayesian estimation described in Sections II and III, and enables historical matching without era adjustment—a capability unavailable to systems operating on raw observed scores, which are contaminated by evaluator drift over time.

B. Multi-Dimensional Similarity Scoring. Within the candidate pool, the system computes a similarity score between the target performer and each historical reference performer. In the preferred embodiment, the similarity computation operates across five weighted dimensions: (1) current-season composite true-skill estimate, (2) per-dimension skill shape profile, (3) prior-season ability estimate, (4) performance trajectory, and (5) multi-year progression path. Continuous dimensions may use Gaussian radial basis function kernels or another kernel function that maps a feature difference to a similarity value.

C. Adaptive Kernel Calibration. The similarity kernel width is calibrated to the pre-filter candidate window width, rather than to the width of the global population distribution. A conventional globally calibrated kernel can create a score-collapse failure mode: once a narrow candidate pool has been selected, many candidates appear almost equally similar because the kernel width remains too broad relative to the candidate band. By tying the kernel width parameter to the candidate window width, the system preserves discrimination among closely matched historical performers and produces more meaningful similarity rankings.

D. Ranked Match Output. The system ranks the historical reference entities according to the multi-dimensional similarity score and outputs one or more matched reference entities. An advancement-outcome weighting may gently prefer matches who went on to advance further in the sport, with a bounded maximum boost, providing users with aspirational yet realistic comparisons. The weighting may affect selection ranking while remaining separated from the stored match quality score, ensuring that displayed similarity percentages reflect genuine multi-dimensional similarity rather than tiebreaker inflation.

The system may produce separate national matches and program-specific matches, with program-specific candidates excluded from the national pool to prevent redundancy. In alternative embodiments, the similarity metric may employ cosine similarity, Mahalanobis distance, learned distance metrics, Siamese networks, or any function that maps pairs of feature vectors to a scalar similarity value.

### IX. Multi-Layer Feature Engineering Architecture

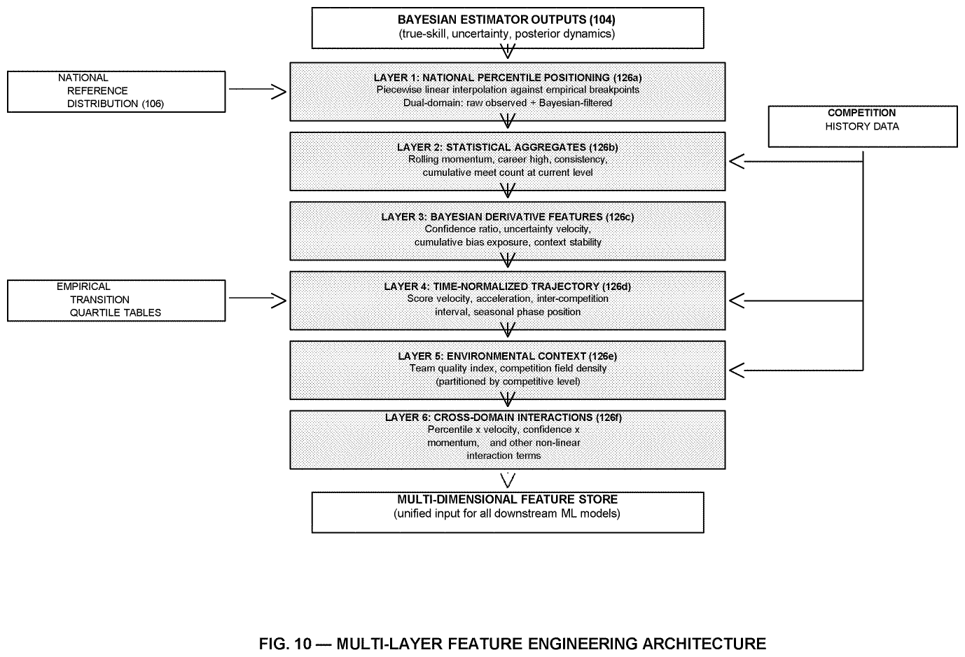

Referring to FIG. 10, the feature engineering module (126) transforms the raw outputs of the Bayesian state estimation module (104) into a multi-dimensional feature store that serves as the unified input for all downstream machine learning models. The feature store is organized into six orthogonal computation layers:
Layer 1—National Percentile Positioning: Each performer's true-skill estimate and raw observed score are evaluated against empirical percentile distributions computed at the national level for the same competitive level, performance dimension, and season. The positioning is computed via piecewise linear interpolation against percentile breakpoints, producing a continuous 0-100 value rather than a discrete bin assignment. Dual-domain positioning (both raw-score and Bayesian-filtered domains) enables downstream models to distinguish between where a performer ranks in judge-observed space versus true-skill space.
Layer 2—Statistical Aggregates: Legacy rolling-window statistics including momentum (short-term score trend), cumulative career high, expanding-window consistency (standard deviation of observed scores), and cumulative meet count at the current competitive level. These features capture aspects of performance history that are complementary to, but distinct from, the Bayesian estimator's summary.
Layer 3—Bayesian Derivative Features: Features derived from the internal dynamics of the Bayesian estimator's posterior state trajectory, including: confidence ratio (signal-to-noise ratio of the true-skill estimate to its uncertainty), uncertainty velocity (rate of change of posterior uncertainty, measuring how quickly the estimator is converging), cumulative bias exposure (aggregate evaluator bias experienced by the performer across all competitions), and context stability (proportion of observations processed in a stable competitive context). These features are structurally impossible to compute without a Bayesian state-space model and represent a key competitive moat.
Layer 4—Time-Normalized Trajectory Features: Features that capture the temporal dynamics of performance including score velocity (points gained per unit time), score acceleration (change in velocity), elapsed time since last competition, and seasonal phase position (early-season, mid-season, late-season). Time normalization accounts for variable inter-competition intervals.
Layer 5—Environmental Context Features: Features encoding the performer's training environment including team quality (aggregate true-skill of teammates at the same competitive level) and competition field density (the strength of the competitive field at recent competitions). These features are partitioned by competitive level to prevent cross-level contamination.
Layer 6—Cross-domain Interaction Features: Engineered Interaction Terms That combine features from different layers, such as national percentile×score velocity (capturing whether a high-ranked performer is accelerating or decelerating) and confidence ratio×momentum (capturing whether a performer with high estimator confidence is maintaining or losing momentum). These interactions encode non-linear relationships that improve machine learning model performance.

The feature engineering module additionally computes difficulty-adjusted transition estimates using empirically derived quartile-based transition tables. For each possible competitive level transition, the system assigns different expected score changes to performers of different ability levels (e.g., a top-quartile performer is expected to experience a smaller score drop when advancing than a bottom-quartile performer). This quartile-matched difficulty adjustment is used as a feature in the downstream prediction models.

In alternative embodiments, the feature layers may be extended with additional computation layers such as geographic features or sport-specific biomechanical features. The number of features may range from as few as 10 to as many as several hundred.

When performer age data is available, age-related variables may be used by the feature store and downstream modules as described further in Section X.

### X. Age-Modulated Estimation and Feature Computation

In certain embodiments, when age, developmental-stage, grade, tenure, or comparable maturity data is available for an entity, the system may use such data to modulate state estimation, feature computation, transition modeling, profiling, and readiness outputs. The age-modulation embodiments are optional and may be omitted when such data is unavailable or unreliable.

A. Age-Modulated Process Noise. The recursive Bayesian state estimator may adjust process-noise parameters based on the age or developmental stage of the entity. Younger or earlier-stage performers may exhibit greater expected variability between observations, while more mature or later-stage performers may exhibit more stable trajectories. The system may therefore increase or decrease process noise as a function of age, developmental stage, tenure, or a learned stability profile.

B. Age-Stratified Tier-Transition Adjustments. Tier-transition adjustments may be stratified by age cohort, developmental-stage cohort, or time-in-level cohort in addition to ability quartile. This allows the system to distinguish between entities that are similarly ranked but at different developmental points. For example, a younger performer and an older performer having similar latent performance estimates may receive different transition expectations because their future growth profiles may differ.

C. Age-Relative Development Features. The feature store may generate age-relative development features that indicate whether an entity is ahead of, on pace with, or behind a peer developmental timeline. Such features may be used as inputs to prediction models, readiness assessments, similarity matching, profiling, or group-level analytics.

D. Downstream Age Modulation. Age-modulated features may be consumed by prediction, readiness, similarity, team analytics, recruiting, or non-sports decision-support modules. In non-athletic embodiments, age may be replaced by tenure, experience level, grade level, time in role, time since intervention, machine age, product lifecycle stage, or another maturity variable appropriate to the domain.

### XI. Team and Program Performance Analytics

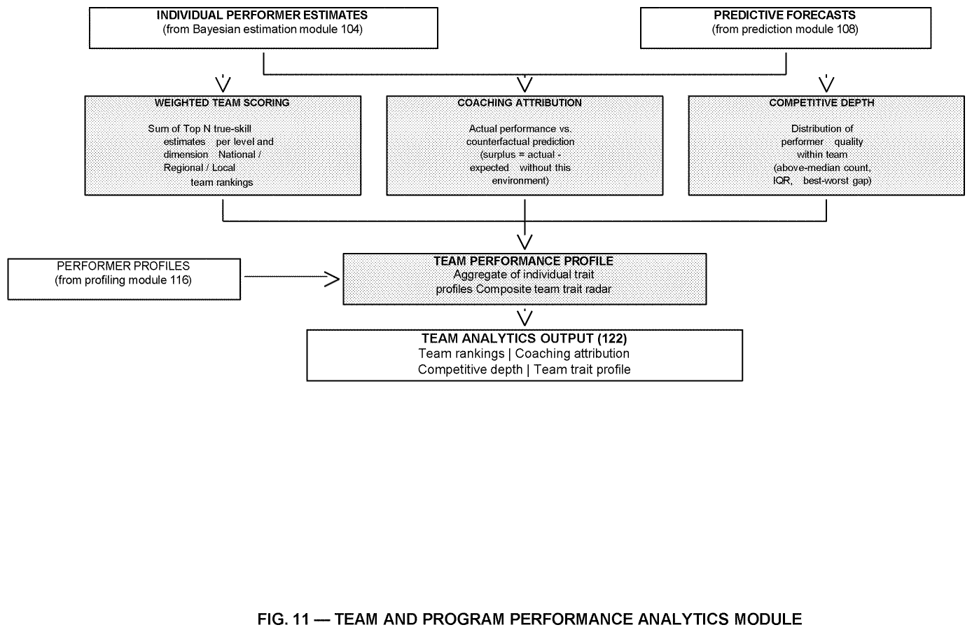

Referring to FIG. 11, the team analytics module (122) aggregates individual performer estimates to produce team-level performance metrics, coaching attribution, and competitive depth analysis.

A. Weighted Team Scoring. The system computes team performance scores by summing the true-skill estimates of the top N performers (in the preferred embodiment, the top 3) at each competitive level and performance dimension. This mirrors the team scoring conventions used in many competitive environments and produces team rankings at the national, regional, and local levels.

B. Coaching Attribution via Counterfactual Comparison. the System Isolates coaching or organizational effect by comparing each entity's actual current-period posterior latent performance estimate to a counterfactual performance estimate generated under a baseline continuation condition. In the preferred embodiment, the counterfactual performance estimate is generated using the predictive modeling module under a same-tier continuation condition, and represents an expected performance level that would be predicted from the entity's historical performance trajectory and feature representation.

Stage 1—Counterfactual prediction generation: for each entity associated with an organizational unit, the system generates a counterfactual performance estimate using the at least one machine learning model. The organizational unit may be a gymnastics team, school department, sales team, clinical practice group, supplier group, operating facility, or other grouping of entities.

Stage 2—Per-entity surplus computation: for each entity, the system computes a surplus value as a difference between the entity's posterior latent performance estimate and the entity's counterfactual performance estimate. A positive surplus indicates that the entity outperformed the baseline continuation prediction, while a negative surplus indicates underperformance relative to the baseline prediction.

Stage 3—Organizational-unit aggregation: the system aggregates the surplus values across the plurality of entities to produce a coaching attribution metric or organizational attribution metric for the organizational unit. In the preferred embodiment, the aggregation uses the top N entities ranked by surplus so that the metric captures the strongest demonstrated outperformance within the organizational unit. Alternative embodiments may use a mean, median, trimmed mean, inverse-uncertainty-weighted mean, percentile statistic, or other aggregation function.

This counterfactual approach differs from a raw comparison between organizations because it uses individualized predictions as the baseline. It also differs from simple season-over-season change because it accounts for the entity's current latent performance estimate, prior trajectory, uncertainty, and feature context. The resulting attribution metric may be output at the entity level, the organizational-unit level, or both, and may be used in ranking, profiling, user-interface display, or downstream decision support.

C. Competitive Depth Analysis. The system measures the distribution of performer quality within each team, computing metrics such as the number of performers above the national median, the inter-quartile range of performer ratings, and the gap between the team's best and worst performers. This depth analysis distinguishes between programs with a few exceptional performers and programs with consistent quality across the roster.

D. Team Performance Profile. The system computes team-level performance profiles by aggregating the individual performer trait profiles (from the profiling module, Section VI), producing a composite team trait radar that characterizes the program's competitive identity, coaching tendencies, and developmental strengths across the trait dimensions. Because the individual traits inherit the Bayesian prerequisite (six of twelve traits require the Bayesian estimator as input), the program-level profile also inherits this prerequisite, enabling comparison of program identities across the competitive landscape in a manner that is structurally impossible without the complete estimation pipeline.

In alternative embodiments, the team scoring may use different top-N thresholds, weighted averages, or median-based aggregations. The coaching attribution may employ more sophisticated causal inference methods such as difference-in-differences, synthetic control methods, or instrumental variable approaches.

### XII. Recruiting Benchmarking System

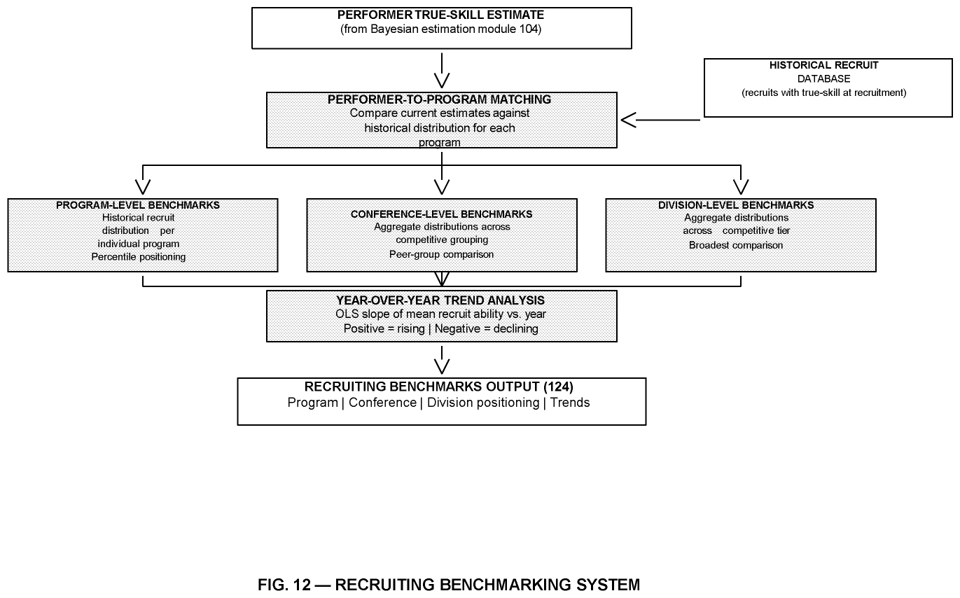

Referring to FIG. 12, the recruiting benchmarking module (124) matches current performer true-skill estimates against historical distributions of performers who were recruited to programs at the next competitive tier (in the preferred embodiment, collegiate programs), producing multi-level benchmarks with trend analysis.

A. Performer-to-Program Matching. The system maintains a database of historical recruits with their corresponding true-skill estimates at the time of recruitment. Each current performer's estimates are compared against the historical distribution for each recruiting program, producing a percentile position showing where the performer falls relative to historical recruits at that program.

B. Hierarchical Benchmarking. The system computes benchmarks at three levels of aggregation: (1) individual program benchmarks (the historical distribution of recruit true-skill estimates at each specific program), (2) conference-level benchmarks (aggregate distributions for all programs within a conference or competitive grouping), and (3) division-level benchmarks (aggregate distributions for all programs within a competitive division or tier).

C. Year-over-Year Trend Analysis. For each program, the system computes the trend of mean recruit true-skill estimates over time using ordinary least squares regression (slope of mean recruit ability vs. recruit year). A positive trend indicates the program's recruiting standards are rising; a negative trend indicates declining selectivity. This trend analysis enables performers and their advisors to assess whether historical benchmarks reflect current recruiting expectations.

In alternative embodiments, the recruiting benchmarking may incorporate additional features such as recruiting timeline analysis (when in the performer's development trajectory do programs typically extend offers), position-specific benchmarking (e.g., benchmarks for performers with specific dimensional strengths), or financial aid estimation based on historical award patterns.

D. Recruiting Program Trait Identity. When the multi-dimensional performance profiling system (Section VI) is combined with the recruiting database, the system can aggregate the normalized trait profiles of performers historically recruited to each next-tier program to produce a program recruiting identity—a characterization of the trait profile that each program preferentially selects. For example, one program may historically recruit performers with high consistency and coaching lift traits, while another preferentially recruits performers with high momentum and pressure performance traits. This recruiting identity enables prospective performers to assess their trait-level alignment with specific programs, providing guidance beyond raw score benchmarking. The program recruiting identity inherits the Bayesian prerequisite of the individual traits: it is structurally impossible to compute without the complete Bayesian estimation and profiling pipeline.

### XIII. Composite System Integration and Chain of Dependency

The system described herein operates as an integrated pipeline where each module depends on the output of upstream modules. This chain of dependency is critical to the system's functioning and represents a key architectural innovation:

Foundation Layer: The evaluator bias estimation module (102, Section III) must execute first, producing bias correction values that are consumed by all downstream modules.

State Estimation Layer: The Bayesian state estimation module (104, Section II) consumes bias-corrected scores and produces true-skill estimates and uncertainty measures. Every downstream product depends on these estimates.

Feature Engineering Layer: The feature engineering module (126, Section IX) consumes Bayesian estimator outputs and produces the multi-layer feature store. All machine learning models consume features from this store.

Product Layer: The rating (110), prediction (108), profiling (116), readiness (118), similarity (120), team analytics (122), and recruiting (124) modules each consume the upstream outputs and produce consumer-facing analytical products.

This layered dependency architecture means the system is a unified invention, not a collection of independent techniques. A competitor cannot produce any of the downstream products without first replicating the upstream infrastructure. The survivorship-corrected predictions (Section IV) require the Bayesian estimator's output; the Bayesian estimator requires bias-corrected scores; the bias correction requires the calibration reference pipeline. Each layer adds value that is impossible without the preceding layers.

Furthermore, the six Bayesian-derived traits in the profiling module (Section VI) traits that are structurally impossible to compute from raw observed scores—create a second chain of dependency that forces any competitor to build the complete Bayesian estimation infrastructure before replicating the profiling system.

Cross-Cutting Age Modulation Layer. When age, tenure, developmental-stage, or maturity data is available, age-modulated processing may be applied after the Foundation and State Estimation layers have produced corrected and transformed posterior values. The age-modulation layer therefore depends on the same upstream infrastructure and may influence feature engineering, prediction, readiness assessment, similarity matching, and group-level analytics without breaking the overall chain of dependency.

### XIV. User Interface Outputs

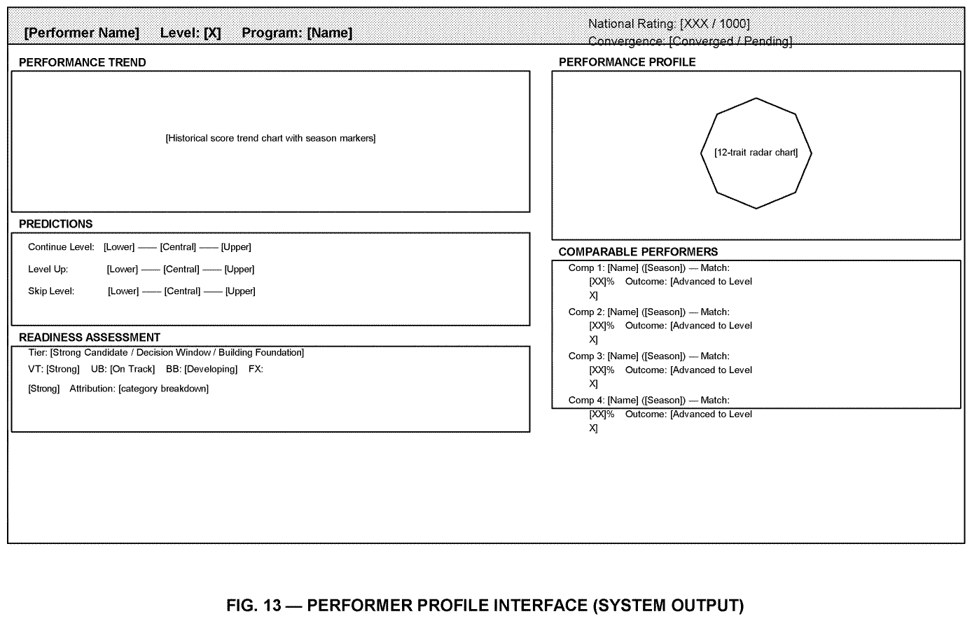

Referring to FIGS. 13 through 16, the system produces interactive user interface outputs that present the analytical products to end users including performers, coaches, parents, and program administrators.

Individual Performer Profile (FIG. 13): An integrated view displaying the performer's true-skill estimate, national percentile rating (with convergence indicator), multi-dimensional performance profile (trait radar), historical performance trend, predictive forecasts for each advancement path, readiness assessment with per-dimension positioning, and historical comparable performers with outcome information.

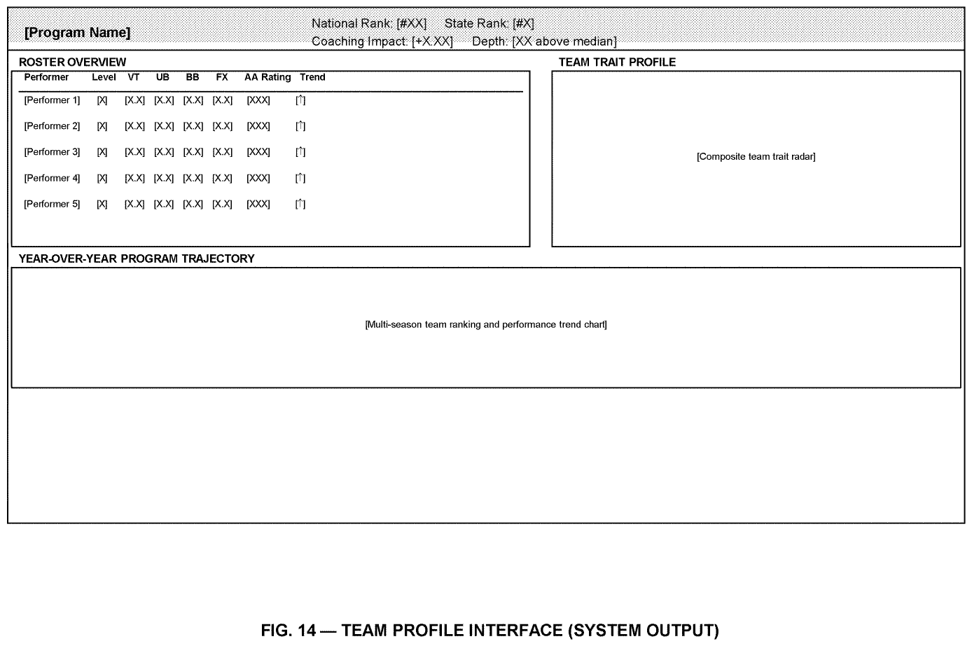

Team Profile (FIG. 14): A program-level view displaying team rankings, roster overview with per-performer ratings, coaching attribution metrics, competitive depth visualization, composite team trait profile, and year-over-year program trajectory.

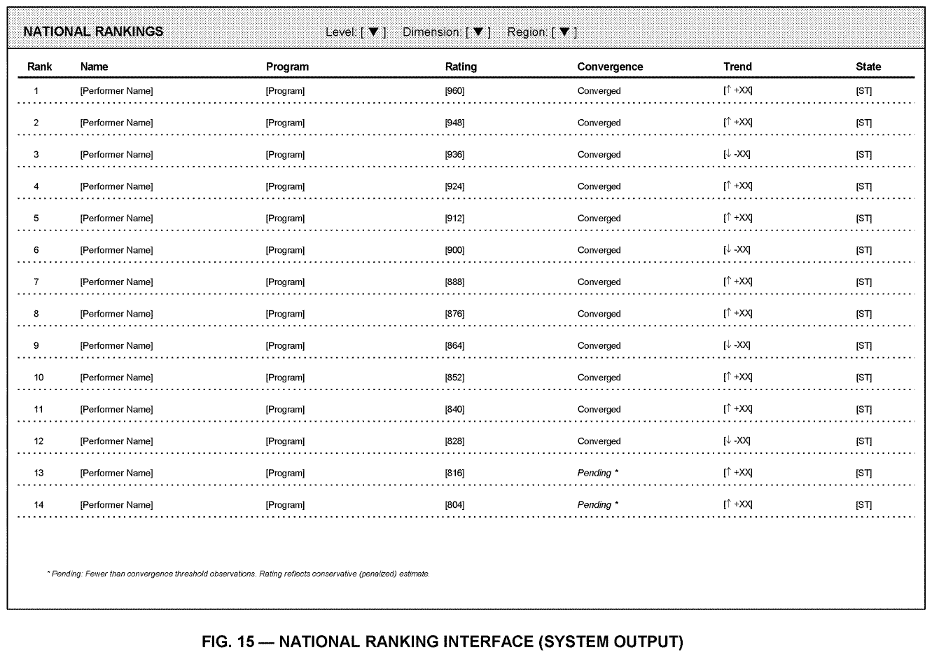

National Ranking (112) (FIG. 15): A ranked list of performers with percentile ratings, convergence indicators distinguishing converged from unconverged estimates, filtering by competitive level and performance dimension, and hierarchical geographic sub-rankings (national, regional, state/province).

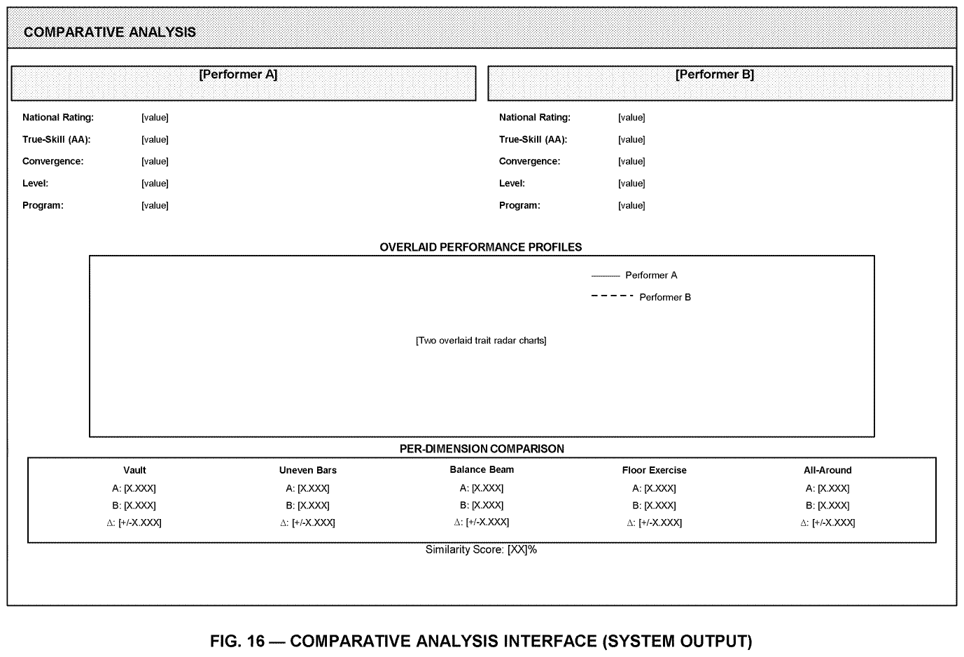

Comparative Analysis (FIG. 16): A side-by-side comparison of two performers showing overlaid performance profiles, per-dimension comparison, and similarity scoring.

In alternative embodiments, the user interface may include additional views such as competition event analysis, head-to-head historical comparison, meet simulation, or coaching dashboards. The interface may be delivered via web application, mobile application, desktop application, or programmatic API.

### ALTERNATIVE EMBODIMENTS AND APPLICATIONS

### A. Alternative Athletic Domains

The system described herein is directly applicable to the following bounded-score athletic domains, among others:
Competitive diving: Scores on a 0-10 scale with judge panels. The bias correction, Bayesian estimation, and rating modules apply with minimal modification.
Figure skating: Technical Element Score (TES) and Program Component Score (PCS) are both bounded. The multi-dimension profiling module extends naturally to the multi-component scoring structure.
Trampoline and tumbling: Bounded 0-10 judging scales with panel evaluation and discrete competitive levels within the same governing body structure as the preferred embodiment.
Surfing: World Surf League (WSL) uses 0-10 panel judging with known evaluator variability.
Skateboarding: Olympic competition uses bounded judging scores.
Martial arts: Belt/rank systems define discrete competitive levels analogous to the level structure described in the preferred embodiment.
Equestrian dressage: Percentage-based scoring (0-100%) with judge panels.
Synchronized swimming: Bounded panel-judged scores with multiple scoring dimensions.

### B. Non-Athletic Applications

The methods described herein, particularly the survivorship bias correction (Section IV. C), the convergence-aware rating (Section V), and the three-tier targeted assessment (Section VII), are applicable to non-athletic domains including:
Educational assessment: Predicting student performance after grade advancement, where training data includes only students who were promoted.
Employee development: Predicting post-promotion performance, where training data includes only employees who received promotions.
Medical treatment adherence: Predicting treatment outcomes, where training data includes only patients who completed treatment protocols.
Financial credit scoring: Predicting loan performance, where training data includes only applicants who were approved.
Military retention forecasting: Predicting post-deployment performance, where training data includes only service members who re-enlisted.
Product quality assessment: Rating products on bounded quality scales where evaluator bias varies across inspection facilities or personnel.

### C. Alternative Estimation Methods

While the preferred embodiment uses a Kalman filter variant, the system architecture supports alternative Bayesian estimation methods including:
Extended Kalman Filter (EKF): Linearizes the observation model at the current state estimate.
Unscented Kalman Filter (UKF): Propagates sigma points through the nonlinearity.
Particle Filter (Sequential Monte Carlo): Represents the posterior distribution as a set of weighted samples.
Gaussian Process Regression: Models the temporal dynamics with a nonparametric Bayesian approach.
Variational Inference: Approximates the posterior distribution using optimization.
Neural network-based state estimators: Learned nonlinear state-space models.

The essential requirement is that the estimation method produce both a point estimate of latent ability and an associated uncertainty measure, enabling the downstream modules (rating, profiling, readiness assessment) to operate on principled Bayesian posterior statistics.

### D. Alternative Transformation Functions

While the preferred embodiment uses the logit transformation, the system supports any monotonic, differentiable link function that maps a bounded interval to an unbounded domain, including:
Probit transformation: Φ-1(s/M), the inverse normal CDF.
Complementary log-log transformation: log(-log(1−s/M)).
Arcsine square-root transformation: arcsin(√(s/M)).
Box-Cox transformation: ((s/M)\hat{ }λ-1)/λ for parameterized λ.
Custom learned transformations: Neural network-based link functions trained on domain-specific data.

### E. Alternative Machine Learning Frameworks

While the preferred embodiment uses an ensemble of gradient-boosted decision tree frameworks for the predictive modeling and readiness assessment modules, the system architecture supports any supervised learning framework including neural networks, random forests, support vector machines, Gaussian processes, logistic regression, or hybrid approaches. The essential requirement is that the framework support quantile estimation (for producing uncertainty intervals) and feature attribution (for producing per-performer explanations).

### EXPANDED APPLICATIONS OUTSIDE COMPETITIVE GYMNASTICS

### A. Generalized Bounded Outcome Environments

Although competitive gymnastics is a preferred embodiment, the disclosed system is applicable to any bounded or semi-bounded outcome environment in which observed data is subject to evaluator bias, environmental bias, measurement noise, longitudinal change, selection bias, or transition effects. The bounded observations may be naturally bounded or may be normalized to a bounded interval before processing.

Across these embodiments, the same technical implementation may be preserved: bounded observations are transformed into an unbounded computational domain; bias associated with an evaluation context is estimated and corrected; recursive Bayesian estimation produces posterior latent states and posterior uncertainty; derivative features are derived from posterior trajectories; and downstream computer modules generate ratings, predictions, profiles, transition readiness assessments, similarity results, or group-level outputs.

### B. Additional Athletic Applications

In additional athletic embodiments, the entities may be athletes, teams, position groups, programs, clubs, schools, or leagues. Performance dimensions may include judged routines, event-specific metrics, skill categories, position-specific metrics, game phases, or time intervals.

The system may be applied to diving, figure skating, surfing, skateboarding, trampoline, tumbling, artistic swimming, dressage, combat sports, cheerleading, esports, racing, swimming, track and field, baseball, basketball, football, soccer, hockey, tennis, golf, martial arts, and other sports in which repeated observations are affected by evaluator context, competitive context, tier transitions, venue effects, level changes, age groups, leagues, or seasonal periods.

In team sports, the bounded observation may be a normalized player grade, scouting grade, execution score, expected-points contribution, plus-minus score, percentile ranking, coach evaluation, or model-generated performance score. The evaluation context may include game venue, opponent strength, position group, coaching scheme, officiating crew, league, season phase, or data-provider source. The system may estimate latent player ability, stabilize noisy observations, correct context effects, predict development, identify readiness for promotion, and generate profiles or comparison groups.

### C. Education, Credentialing, and Training

In educational and credentialing embodiments, the entities may be students, examinees, applicants, teachers, schools, classes, departments, training cohorts, or credentialing programs. Bounded observations may include test scores, assignment rubrics, course grades, standardized assessment scores, GPA values normalized to a bounded scale, certification scores, licensure results, skill checklists, or evaluator rubrics.

The evaluation context may include teacher, grader, school, course section, testing center, test form, curriculum, institutional grading policy, or peer cohort. The system may estimate latent academic ability, correct evaluator or institution bias, predict advancement success, identify readiness for a next course or credential level, detect destabilizing uncertainty trends, and generate explanatory profiles for students, programs, or institutions.

### D. Employment, Sales, and Human Performance

In employment and human-performance embodiments, the entities may be employees, sales representatives, managers, trainees, call-center agents, drivers, operators, recruiters, or organizational units. Bounded observations may include performance review scores, sales attainment scores, customer satisfaction ratings, training scores, productivity scores, error-rate scores, safety scores, promotion-readiness ratings, or peer-review scores.

The evaluation context may include manager identity, business unit, territory, shift, customer segment, market condition, reviewer, product line, or operational environment. The system may estimate latent job performance, account for evaluator or manager bias, forecast promotion success, detect stabilization or destabilization in performance, and provide coaching or development outputs.

### E. Healthcare and Clinical Outcomes

In healthcare embodiments, the entities may be patients, providers, surgeons, clinics, hospitals, procedures, care teams, treatment programs, devices, or therapies. Bounded observations may include patient-reported outcome measures, recovery scores, adherence scores, quality-of-care ratings, treatment response scores, complication-risk scores, provider performance ratings, or institutional quality metrics.

The evaluation context may include provider, facility, patient-mix, procedure type, measurement instrument, rater, time since intervention, treatment protocol, or population baseline. The system may correct for evaluator, facility, patient-mix, or measurement bias, estimate latent treatment response or provider quality, track uncertainty convergence, predict transition or intervention readiness, and generate explanatory outputs for clinical review.

### F. Finance, Insurance, Credit, and Risk

In finance, insurance, credit, and risk embodiments, the entities may be borrowers, insureds, accounts, traders, portfolios, vendors, counterparties, claims, merchants, or financial products. Bounded observations may include credit scores, payment reliability scores, underwriting scores, claims-risk scores, portfolio performance scores, compliance scores, fraud-risk scores, vendor risk ratings, or trust scores.

The evaluation context may include lender, underwriter, market regime, product type, geography, reporting source, economic cycle, account segment, or portfolio manager. The system may estimate latent reliability or risk while correcting for evaluator, environment, market, or data-source bias, and may generate forecasts, readiness outputs, early warning indicators, and peer-group comparisons.

### G. Industrial, Manufacturing, Supplier, and Operational Systems

In industrial, manufacturing, and operational embodiments, the entities may be machines, components, suppliers, production lines, products, service teams, logistics routes, facilities, software systems, or manufacturing lots. Bounded observations may include quality inspection scores, defect severity scores, machine health scores, supplier performance ratings, delivery reliability scores, process capability scores, maintenance readiness scores, cybersecurity posture scores, or safety audit scores.

The evaluation context may include inspector, plant, production line, sensor type, measurement method, supplier class, operating environment, shift, material batch, route, weather condition, or maintenance history. The system may estimate latent quality or reliability, correct inspection-context bias, predict future failure or improvement, identify readiness for maintenance or release, and generate operational profiles or group-level analytics.

### TECHNICAL IMPROVEMENTS AND COMPUTER IMPLEMENTATION

The disclosed system improves computer processing of bounded, biased, noisy longitudinal observations. Conventional computer systems often treat bounded observations as linear measurements, ignore evaluation-context bias, discard uncertainty trajectories, or generate rankings from raw averages. The disclosed architecture instead performs a specific sequence of computer operations that includes evaluation-context bias correction, bounded-to-unbounded domain transformation, derivative-based noise conversion, recursive Bayesian state estimation, posterior uncertainty tracking, multi-layer feature generation, and downstream generation of concrete data outputs.

The system generates intermediate computational states, including transformed-domain posterior variables and uncertainty trajectories, that do not exist in the source data and that are required for subsequent processing steps.

The transformation to an unbounded computational domain permits a recursive Bayesian estimator to process bounded measurements without treating equal point differences as equal latent performance changes across the entire scale. The local derivative bridge allows noise parameters that are meaningful in the bounded score domain to be converted dynamically into the transformed domain at each update. This reduces systematic distortion near the boundaries of a bounded scale and improves the stability and interpretability of stored posterior estimates.

The generated posterior uncertainty trajectory is not a generic output of raw score averaging. It provides a computer-generated state variable that may be used to generate convergence-aware ratings, derivative features, stability indicators, readiness outputs, and predictive uncertainty intervals. These features are structurally dependent on the recursive estimator and cannot be computed from a simple list of raw observations alone.

The system may store the generated posterior latent performance estimates, posterior uncertainty estimates, feature vectors, predictions, profiles, ratings, readiness labels, similarity results, group analytics, and audit records in one or more non-transitory memories or databases. The outputs may be transmitted through an application programming interface, displayed through a web application or mobile application, exported as tabular records, or used to control downstream decision-support workflows.

The specification provides implementation details for bias correction, transformation, Bayesian update, derivative conversion, feature generation, prediction, profiling, readiness assessment, similarity matching, team analytics, recruiting benchmarking, and user interface outputs. A person of ordinary skill in data science, software engineering, or statistical modeling can implement the described system using conventional processors, databases, non-transitory memory, and programming languages without undue experimentation.

### CONTINUATION AND DIVISIONAL SUPPORT

The present application includes disclosure supporting multiple related implementations. The initial claim set focuses on the integrated system architecture, transformed-domain Bayesian state estimation, and predictive and explanatory outputs generated from posterior estimates and derivative features. Additional subject matter described herein may be pursued in one or more continuation or divisional applications.

Potential continuation subject matter includes, without limitation, detailed team analytics, recruiting benchmarks, trophy and gamification outputs, particular trait formulas such as lock-in, clutch factor, hot hand, and coaching lift, specific user interface dashboards, historical similarity matching kernels, detailed NCAA or institutional benchmarking, and domain-specific adaptations for non-sports environments.

Unless otherwise specified, each module described herein may be implemented as one or more software components executed by one or more processors, and may be distributed across local or remote computing environments.

The foregoing description has been presented for purposes of illustration and description and is not intended to be exhaustive or to limit the invention to the precise forms disclosed. The embodiments described herein may be modified in arrangement, operation, sequence, components, data structures, models, thresholds, and computational techniques without departing from the scope of the invention. The scope of the invention is defined by the claims and their equivalents.

1. A computer-implemented performance analytics system comprising: one or more processors; and one or more non-transitory computer-readable media storing instructions that, when executed by the one or more processors, cause the system to:
receive bounded performance observations for a plurality of entities, each bounded performance observation being associated with an entity, a performance dimension, an evaluation context, and a time;
generate, using an evaluation-context bias correction engine, bias-corrected bounded performance observations by estimating a relative bias for one or more evaluation contexts from calibration residuals and applying the relative bias to corresponding bounded performance observations;
transform the bias-corrected bounded performance observations from a bounded score domain to an unbounded transformed domain using a monotonic differentiable link function;
generate, using a recursive Bayesian state estimator operating in the unbounded transformed domain, a posterior latent performance estimate and a posterior uncertainty estimate for each entity and performance dimension;
convert the posterior latent performance estimate and the posterior uncertainty estimate into the bounded score domain; generate a multi-layer feature representation comprising at least one feature derived from a trajectory of the posterior uncertainty estimate; and
generate an analytical output comprising at least one of a normalized rating, a future performance prediction, a multi-dimensional performance profile, a transition readiness assessment, a similarity match, or a group-level analytics output.

2. The system of claim 1, wherein the bounded performance observations comprise scores from a judged athletic environment selected from gymnastics, diving, figure skating, surfing, trampoline, tumbling, skateboarding, dressage, artistic swimming, combat sports judging, or another judged competitive activity.

3. The system of claim 1, wherein the bounded performance observations comprise non-athletic bounded observations selected from academic assessment scores, employee performance scores, sales performance scores, credit or underwriting scores, medical outcome scores, product quality scores, supplier performance scores, or machine condition scores.

4. The system of claim 1, wherein estimating the relative bias comprises identifying calibration entities having at least a threshold amount of prior observation history in a corresponding performance dimension and computing calibration residuals between observed performance and expected performance for the calibration entities.

5. The system of claim 4, wherein the evaluation-context bias correction engine censors a one-sided outlier tail of the calibration residuals to reduce contamination from catastrophic performance events while preserving residuals in an opposite tail.

6. The system of claim 1, wherein estimating the relative bias comprises applying, in sequence, empirical centering, evidence-based shrinkage, and smooth bounded compression to raw evaluation-context bias estimates.

7. The system of claim 6, wherein empirical centering comprises subtracting a population mean of eligible raw evaluation-context bias estimates, evidence-based shrinkage comprises applying a weight based on a number of calibration residuals, and smooth bounded compression comprises applying a piecewise nonlinear bounding function having a passthrough region and an asymptotic cap.

8. The system of claim 1, wherein the monotonic differentiable link function comprises a logit transformation applied to a normalized bounded performance observation, and wherein the system converts an updated posterior estimate back into the bounded score domain using an inverse logit transformation.

9. The system of claim 1, wherein the recursive Bayesian state estimator uses a local derivative of the monotonic differentiable link function to convert at least one noise parameter from the bounded score domain into the unbounded transformed domain at an iteration of the recursive Bayesian state estimator.

10. The system of claim 1, wherein the analytical output comprises a normalized rating generated by evaluating the posterior latent performance estimate against a reference distribution for a corresponding peer group, and wherein the normalized rating is reduced for an unconverged entity based on the posterior uncertainty estimate.

11. A computer-implemented method for estimating latent performance ability from bounded observations, the method comprising:
receiving, by one or more processors, a time-ordered sequence of bounded observations for an entity in a performance dimension;
obtaining an evaluation-context bias value associated with at least one bounded observation in the time-ordered sequence;
generating a bias-corrected observation by adjusting the at least one bounded observation using the evaluation-context bias value;
transforming the bias-corrected observation into an unbounded transformed domain using a monotonic differentiable link function;
executing a recursive Bayesian predict-correct update in the unbounded transformed domain, wherein the recursive Bayesian predict-correct update maintains a posterior mean and a posterior uncertainty;
dynamically converting a measurement noise parameter or process noise parameter from the bounded observation domain to the unbounded transformed domain using a local derivative of the monotonic differentiable link function; and
outputting a latent performance score and an uncertainty score in the bounded observation domain.

12. The method of claim 11, further comprising selecting a context-dependent prediction mode from at least a stable-context mode, a tier-transition mode, and a temporal-boundary mode before performing the recursive Bayesian predict-correct update.

13. The method of claim 12, wherein the tier-transition mode applies an empirically derived transition adjustment in the bounded observation domain and injects additional posterior uncertainty before the correction portion of the recursive Bayesian predict-correct update.

14. The method of claim 12, wherein the temporal-boundary mode applies a temporal adjustment and injects additional posterior uncertainty associated with an interval between observation periods.

15. A computer-implemented method for generating predictive and explanatory performance outputs from bounded observations, the method comprising:
receiving posterior latent performance estimates and posterior uncertainty estimates generated by a recursive Bayesian state estimator from bounded observations;
generating a feature store comprising population positioning features, statistical aggregate features, Bayesian derivative features, time-normalized trajectory features, evaluation-context or environmental context features, and cross-domain interaction features;
training or applying at least one machine learning model using a delta target representing a change from a current posterior latent performance estimate to a future performance outcome;
generating a future performance prediction by combining the current posterior latent performance estimate with a predicted delta; generating a multi-dimensional performance profile comprising traits derived at least in part from the posterior uncertainty estimates or a trajectory of the posterior uncertainty estimates; and
generating a transition readiness output for at least a subset of entities based on the feature store.

16. The method of claim 15, wherein the Bayesian derivative features comprise at least one of a confidence ratio, an uncertainty velocity, a cumulative bias exposure feature, or a context stability feature.

17. The method of claim 15, wherein generating the future performance prediction comprises applying separate model populations for same-tier predictions and tier-transition predictions and routing an entity to one of the separate model populations based on a hypothetical prediction path.

18. The method of claim 15, wherein generating the future performance prediction for a tier-transition path comprises replacing a model-derived center estimate with an empirical center estimate derived from transition data while preserving a model-derived uncertainty spread.

19. The method of claim 15, wherein the analytical output further comprises a coaching attribution metric for at least one organizational unit comprising a plurality of entities, wherein the coaching attribution metric is generated by: (a) generating, for each of the plurality of entities, a counterfactual performance estimate using the at least one machine learning model under a baseline continuation condition; (b) computing, for each of the plurality of entities, a surplus value as a difference between the entity's posterior latent performance estimate and the entity's counterfactual performance estimate; and (c) aggregating the surplus values across the plurality of entities to produce the coaching attribution metric for the organizational unit.

20. The method of claim 15, wherein the analytical output further comprises a similarity match between a target entity and one or more historical reference entities, wherein generating the similarity match comprises: (a) constructing a candidate pool of historical reference entities at a same competitive tier as the target entity and within a candidate window of posterior latent performance estimates surrounding the target entity's posterior latent performance estimate; (b) computing a multi-dimensional similarity score between the target entity and each historical reference entity in the candidate pool using a kernel function having a kernel width parameter, wherein the kernel width parameter is calibrated as a function of a width of the candidate window rather than a width of a global population distribution; and (c) ranking the historical reference entities according to the multi-dimensional similarity score and outputting at least one matched reference entity.
